(19) United States
(12) Patent Application Publication
(10) Pub. No.: US 2022/0237415 A1
(43) Pub. Date: Jul. 28, 2022

(54) PRIORITY-BASED, ACCURACY-CONTROLLED INDIVIDUAL FAIRNESS OF UNSTRUCTURED TEXT

(71) Applicant: International Business Machines Corporation, Armonk, NY (US)

(72) Inventors: Pranay Kumar Lohia, Bangalore (IN); Deepak Vijaykeerthy, Bangalore (IN); Diptikalyan Saha, Bangalore (IN); Nishtha Madaan, Haryana (IN); Naveen Panwar, Bangalore (IN)

(21) Appl. No.: 17/161,125

(22) Filed: Jan. 28, 2021

(51) Int. Cl. G06K 9/62; G06N 20/00; G06F 16/35

(52) U.S. Cl. CPC G06K 9/6262; G06N 20/00; G06F 16/35; G06K 9/627; G06K 9/6259

(57) ABSTRACT

Methods, systems, and computer program products for priority-based, accuracy-controlled individual fairness of unstructured text are provided herein. A method includes identifying one or more samples in a set of data used to train a machine learning model having at least one attribute; generating counterfactual samples for each of the one or more identified samples; calculating scores for the one or more identified samples based at least in part on output of the machine learning model with respect to the counterfactual samples, wherein the scores indicate a relative level of bias between the one or more identified samples corresponding to the at least one attribute; creating an enhanced set of data at least in part by supplementing at least a portion of the identified samples with the corresponding counterfactual samples based on the calculated scores; and training the machine learning model using the enhanced set of data.

### BACKGROUND

The present application generally relates to information technology and, more particularly, to controlling fairness of unstructured text for machine learning models.

Generally, machine learning algorithms represent software models that are trained based on data to make predictions or decisions. Such predictions or decisions reflect the choices that were made when building the models. For example, the output of a software model will reflect any bias that is present in the training data.

### SUMMARY

In one embodiment, techniques for priority-based, accuracy-controlled individual fairness of unstructured text are provided. An exemplary computer-implemented method can include steps of identifying one or more samples in a set of data used to train a machine learning model having at least one attribute; generating one or more counterfactual samples for each of the one or more identified samples; calculating scores for the one or more identified samples based at least in part on output of the machine learning model with respect to the counterfactual samples, wherein the scores indicate a relative level of bias between the one or more identified samples corresponding to the at least one attribute; creating an enhanced set of data at least in part by supplementing at least a portion of the identified samples with the corresponding one or more counterfactual samples based on the calculated scores; and training the machine learning model using the enhanced set of data.

Another embodiment, or elements thereof, can be implemented in the form of a computer program product tangibly embodying computer readable instructions which, when implemented, cause a computer to carry out a plurality of method steps, as described herein. Furthermore, another embodiment, or elements thereof, can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a system architecture, according to an exemplary embodiment;

FIG. 2 is a flow diagram for identifying protected attributes in unstructured text, according to an exemplary embodiment;

FIG. 3 shows example pseudocode of a process for priority-based, accuracy-controlled individual fairness of unstructured text, according to an exemplary embodiment.

FIG. 4 is a flow diagram for priority-based, accuracy-controlled individual fairness of unstructured text, according to an exemplary embodiment;

FIG. 5 is a system diagram of an exemplary computer system on which at least one embodiment of the present disclosure can be implemented;

FIG. 6 depicts a cloud computing environment according to an embodiment; and

FIG. 7 depicts abstraction model layers according to an embodiment of the present disclosure.

### DETAILED DESCRIPTION

Individual discrimination in text is present, for example, when the prediction of a model changes for a given classifier in response to changing a protected class attribute of a sample of the text. For instance, consider the following sample of text “my boss is younger than I am,” and the following counterfactual “my boss is older than I am.” If the prediction of a model (e.g., a sentiment text classification model) changes for these two samples, then the model is considered to have an age-related bias.

Conventional techniques to address fairness of machine learning models generally include pre-processing or in-processing based individual fairness in text. Generally, such conventional techniques suffer from one or more of the following disadvantages: failure to achieve a sufficient level fairness, compromise on text that might have less bias than other text, and failure to control drops in accuracy while trying to achieve individual fairness.

As described herein, embodiments of the present disclosure include improved techniques for priority-based, accuracy-controlled individual fairness of unstructured text. Such embodiments may include, for example, calculating unfairness quotients for samples of unstructured text and limiting the samples of the unstructured text to be debiased based on the unfairness quotients. According to at least one embodiment, samples of unstructured text having less individual bias are prioritized over other samples to control the accuracy of a machine learning model. Further, one or more exemplary embodiments include identifying layers of the machine learning model that contribute to unfairness and prioritizing the identified layers for de-biasing.

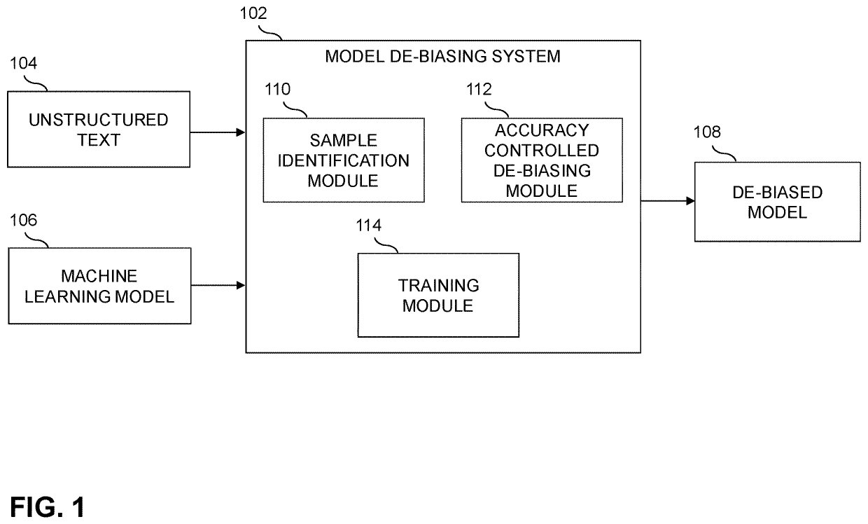

FIG. 1 is a diagram illustrating a system architecture, according to an embodiment. By way of illustration, FIG. 1 depicts a model de-biasing system 102 that obtains unstructured text 104 and a machine learning model 106, and the model de-biasing system 102 outputs a de-biased model 108. In the FIG. 1 embodiment, the model de-biasing system 102 includes a sample identification module 110, an accuracy controlled de-biasing module 112, and a training module 114.

The sample identification module 110 identifies samples of the unstructured text 104 relating to a protected attribute. Protected attributes, as used herein, generally refers to particular attributes that are to be de-biased, such as, for example, gender, age, nationality, etc.

The accuracy controlled de-biasing module 112 calculates an unfairness quotient for each of the samples identified as relating to a protected attribute and ranks, or prioritizes, the samples based on the calculated unfairness quotient. The accuracy controlled de-biasing module 112 debiases the samples of text based on the ranking while controlling an accuracy of the machine learning model 106. The training module 114 trains, or re-trains, the machine learning model 106 using the debiased data to obtain the de-biased model 108, as described in more detail elsewhere herein.

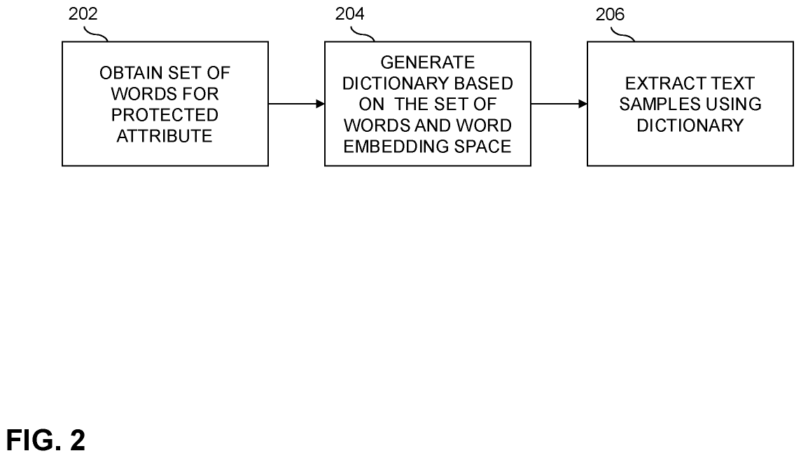

FIG. 2 is a flow diagram for identifying protected attributes in unstructured text, according to an exemplary embodiment. Generally, the process depicted in FIG. 2 uses a set of predefined keywords in the form of a dictionary to identify and/or extract samples of text that include a particular protected attribute. It is noted that the FIG. 2 embodiment is described with respect to a single protected attribute; however, it is to be appreciated that such techniques may be used to detect multiple attributes, such as, for example, by generating a dictionary for each of the multiple attributes.

Step 202 of FIG. 2 includes obtaining a set of words for the protected attribute. For example, if the protected attribute corresponds to age, then the set of keywords comprises a list of age-related terms, which can be manually curated and/or obtained from one or more online resources, for example. As such, the set of words at step 202 can be referred to as “seed” words for the protected attribute. Step 204 includes generating a dictionary based on the set of words obtained at step 202 and a word embedding space. Step 204 may include identifying words within a specified distance of word embedding space for each word in the set and adding these words to the dictionary. As an example, if the word “young” is used as a seed word, then the following list of words may be obtained based on the word embedding space: children, kids, teens, teenager, youngster, youths, teenagers, young, younger, youngest. According to at least one embodiment, such sets may also be used to generate counterfactuals (or perturbations), as described in more detail elsewhere herein. Perturbing a sample generally refers to a process that modifies at least some of the text of the sample to generate a new, perturbed sample. By way of example, if a sample of text corresponds to a sentence that includes the word “young,” then the sample can be perturbed by replacing the word “young” with each of the words in the list above, for example. Step 206 includes extracting text samples based on the dictionary generated at step 204.

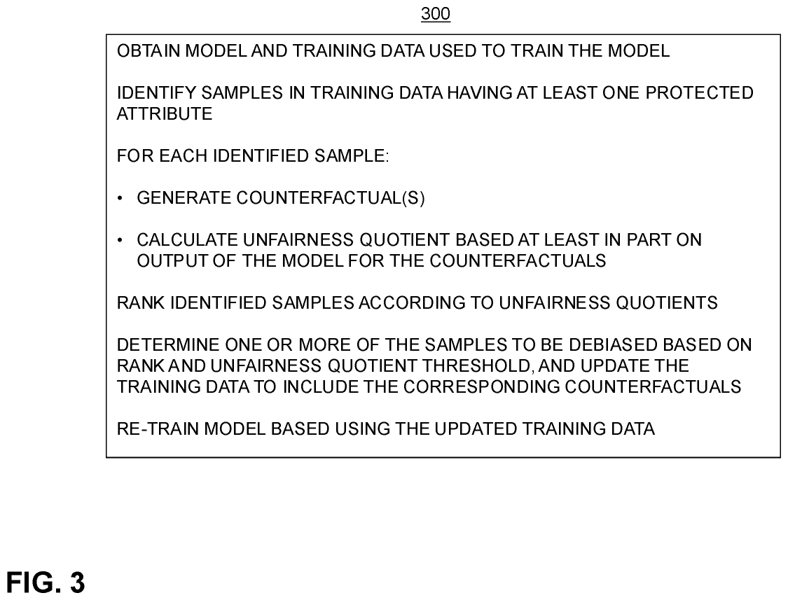

FIG. 3 shows example pseudocode 300 of a process for priority-based, accuracy-controlled individual fairness of unstructured text, according to an exemplary embodiment. The example pseudocode 300 is representative of computer code that may be executed by or under the control of at least one processing system and/or device. For example, the example pseudocode 300 may be viewed as comprising a portion of a software implementation of at least part of the mode de-biasing system 102 of the FIG. 1 embodiment.

The pseudocode 300 includes obtaining a machine learning model and training data used to train the model, which may include, for example, unstructured text. The pseudocode 300 includes identifying samples that have at least one protected attribute. The samples may be identified using dictionaries, such as described above in conjunction with FIG. 2, for example. For each identified sample, counterfactual(s) may be generated based on the corresponding dictionary. An unfairness quotient is calculated for each identified sample based at least in part on the output of the model with respect to the counterfactuals. For example, the unfairness quotient may be calculated as the difference in a prediction score associated with a class label between the original sample and counterfactuals. Each identified sample is then ranked according to the unfairness quotients. The pseudocode 300 determines which of the samples are to be debiased based on the rank and an unfairness quotient threshold. The training data is updated to include the counterfactuals corresponding to the samples that are to be debiased, and the model is trained (or re-trained) using the updated training data.

In at least some examples, counterfactuals (e.g., perturbed sentences) are generated in ascending order of the unfairness quotient value. Additionally, it is noted that samples having a lower unfairness quotient generally have less of an effect on the accuracy of the model than samples having a higher unfairness quotient. Further, the unfairness quotient threshold in the pseudocode 300 can correspond to a hyperparameter, which can be tuned based on the amount of control needed over accuracy of the model. As such, the model can be re-trained so that it is less capable of distinguishing between different groups in a protected attribute, while controlling the accuracy of the model.

One or more example embodiments include prioritizing particular layers of the machine learning model when re-training the model. For example, for each sample having at least one protected attribute, the prioritization can be performed as follows:
Calculate a divergence, Dᵢ, in the internal representations of each layer, for both the identified sample and the counterfactuals, denoted by Lᵢ(x) and Lᵢ(x′), respectively. For example, the divergence can be equal to: 1−cosine (Lᵢ(x), Lᵢ(x′)).
Rack each layer of the machine learning model for its contribution towards unfairness based on the computed divergences.
Re-train only a specified number of the layers (e.g., top-k), while freezing the remaining layers.

Such a prioritization process increases the performance of re-training and allows the re-training to focus only on the parts of the model that contribute most to unfairness.

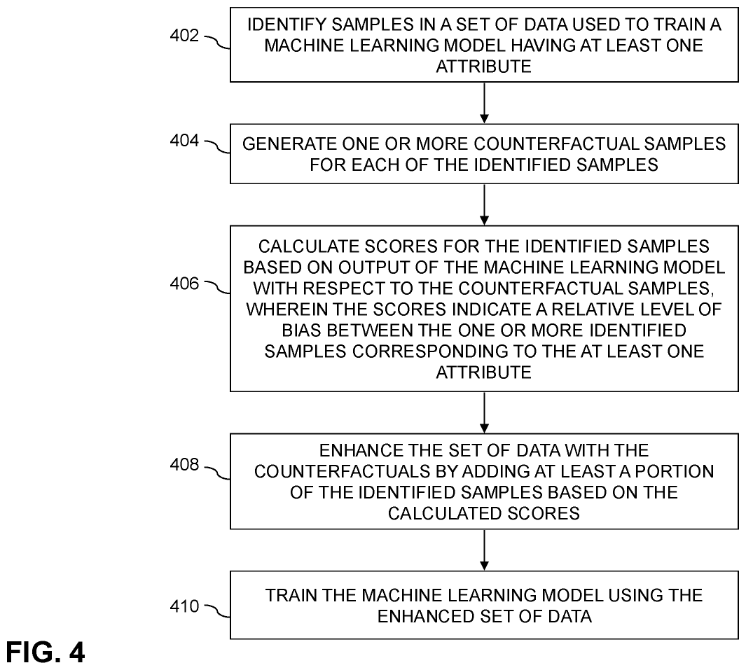

FIG. 4 is a flow diagram illustrating techniques according to an exemplary embodiment. Step 402 includes identifying one or more samples in a set of data used to train a machine learning model having at least one attribute. Step 404 includes generating one or more counterfactual samples for each of the one or more identified samples. Step 406 includes calculating scores for the one or more identified samples based at least in part on output of the machine learning model with respect to the counterfactual samples, wherein the scores indicate a relative level of bias between the one or more identified samples corresponding to the at least one attribute. Step 408 includes creating an enhanced set of data at least in part by supplementing at least a portion of the identified samples with the corresponding one or more counterfactual samples based on the calculated scores. Step 410 includes training the machine learning model using the enhanced set of data.

Calculating the score for a given one of the identified samples is based on a comparison of the output of the machine learning model for the given sample with the output of the machine learning model for the corresponding one or more counterfactual samples. The creating may include controlling an accuracy of the machine learning model by supplementing only the identified samples having scores above a threshold value with the corresponding one or more counterfactual samples. The threshold value may include a tunable hyperparameter. A given one of the identified samples may be identified using a set of keywords associated with the at least one attribute that is generated based at least in part on a word embedding space. Generating the one or more counterfactual samples may include using the set of keywords to generate perturbations of the given identified sample. The process depicted in FIG. 4 may further include the steps of determining an impact of the one or more counterfactual samples relative to the corresponding identified sample at each of a plurality of layers of the machine learning model; and retraining only a portion of the plurality of the layers of the machine learning model based on the determined impact at each of the layers. The at least one attribute may be related to at least one of: gender, age, and nationality.

The techniques depicted in FIG. 4 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In one embodiment, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 4 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the present disclosure or elements thereof can be implemented in the form of an apparatus including a memory and at least one processor that is coupled to the memory and configured to perform exemplary method steps.

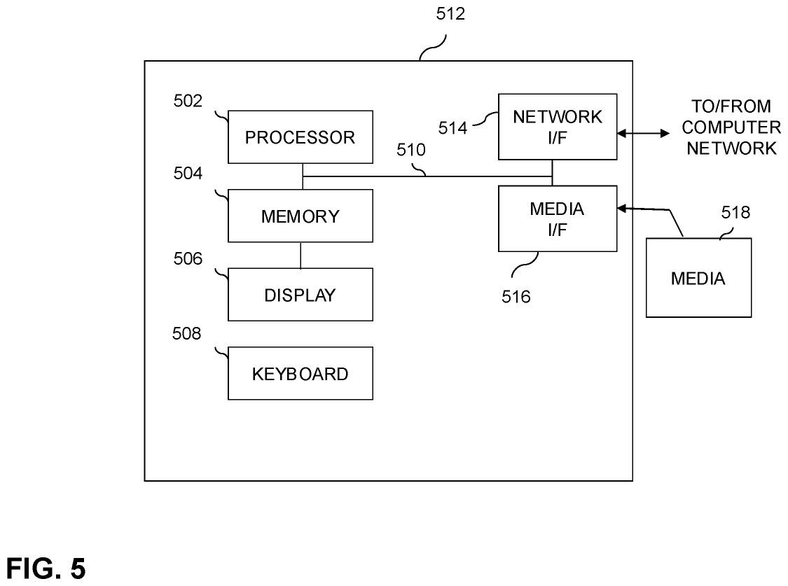

Additionally, an embodiment of the present invention can make use of software running on a computer or workstation. With reference to FIG. 5, such an implementation might employ, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 502. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

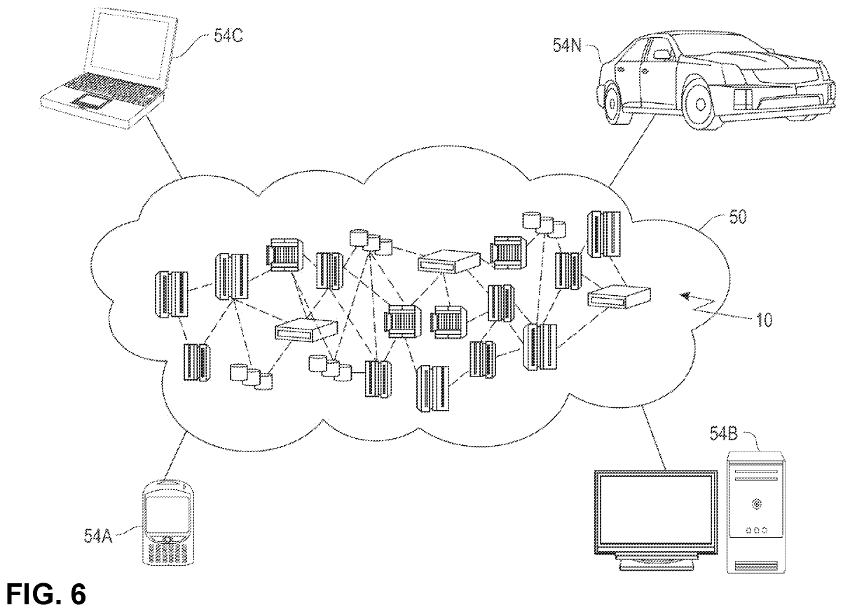

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

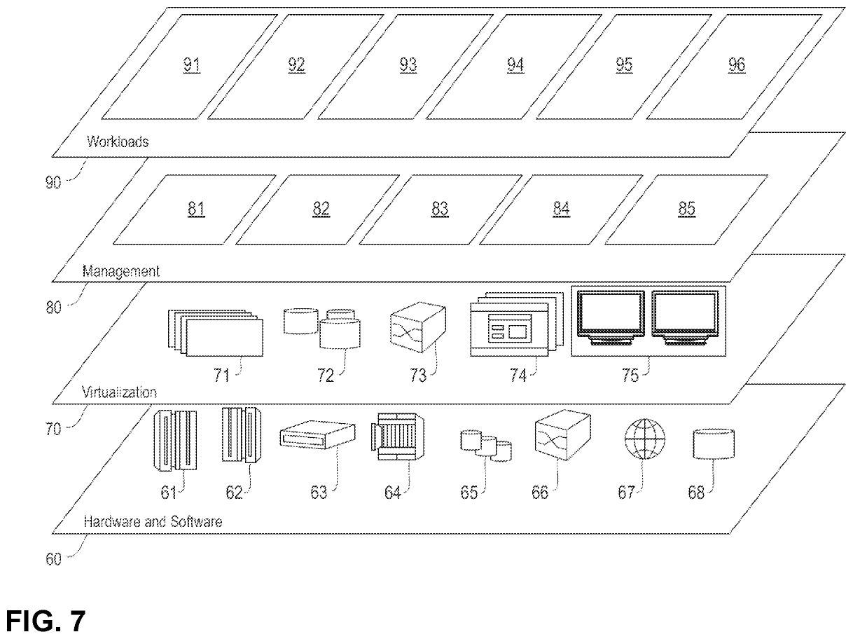

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and priority-based, accuracy-controlled individual fairness of unstructured text 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present disclosure provides a beneficial effect such as, for example, reducing bias while controlling accuracy of machine learning models. Additionally, at least one embodiment of the present disclosure provides a beneficial effect such as, for example, improved machine learning training techniques to reduce bias, by targeting specific layers of the machine learning model.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
identifying one or more samples in a set of data used to train a machine learning model having at least one attribute;
generating one or more counterfactual samples for each of the one or more identified samples;
calculating scores for the one or more identified samples based at least in part on output of the machine learning model with respect to the counterfactual samples, wherein the scores indicate a relative level of bias between the one or more identified samples corresponding to the at least one attribute;
creating an enhanced set of data at least in part by supplementing at least a portion of the identified samples with the corresponding one or more counterfactual samples based on the calculated scores; and
training the machine learning model using the enhanced set of data;
wherein the method is performed by at least one computing device.

2. The computer-implemented method of claim 1, wherein calculating the score for a given one of the identified samples is based on a comparison of the output of the machine learning model for the given sample with the output of the machine learning model for the corresponding one or more counterfactual samples.

3. The computer-implemented method of claim 1, wherein said creating comprises:
controlling an accuracy of the machine learning model by supplementing only the identified samples having scores above a threshold value with the corresponding one or more counterfactual samples.

4. The computer-implemented method of claim 3, wherein the threshold value comprises a tunable hyperparameter.

5. The computer-implemented method of claim 1, wherein a given one of the identified samples is identified using a set of keywords associated with the at least one attribute that is generated based at least in part on a word embedding space.

6. The computer-implemented method of claim 5, wherein generating the one or more counterfactual samples comprises using the set of keywords to generate perturbations of the given identified sample.

7. The computer-implemented method of claim 1, further comprising:
determining an impact of the one or more counterfactual samples relative to the corresponding identified sample at each of a plurality of layers of the machine learning model; and
retraining only a portion of the plurality of the layers of the machine learning model based on the determined impact at each of the layers.

8. The computer-implemented method of claim 1, wherein the at least one attribute is related to at least one of: gender, age, and nationality.

9. The computer-implemented method of claim 1, wherein software is provided as a service in a cloud environment.

10. A computer program product comprising a computer readable storage medium having program instructions embodied therewith, the program instructions executable by a computing device to cause the computing device to:
identify one or more samples in a set of data used to train a machine learning model having at least one attribute;
generate one or more counterfactual samples for each of the one or more identified samples;
calculate scores for the one or more identified samples based at least in part on output of the machine learning model with respect to the counterfactual samples, wherein the scores indicate a relative level of bias between the one or more identified samples corresponding to the at least one attribute;
create an enhanced set of data at least in part by supplementing at least a portion of the identified samples with the corresponding one or more counterfactual samples based on the calculated scores; and
train the machine learning model using the enhanced set of data.

11. The computer program product of claim 10, wherein calculating the score for a given one of the identified samples is based on a comparison of the output of the machine learning model for the given sample with the output of the machine learning model for the corresponding one or more counterfactual samples.

12. The computer program product of claim 10, wherein said creating comprises:
controlling an accuracy of the machine learning model by supplementing only the identified samples having scores above a threshold value with the corresponding one or more counterfactual samples.

13. The computer program product of claim 12, wherein the threshold value comprises a tunable hyperparameter.

14. The computer program product of claim 10, wherein a given one of the identified samples is identified using a set of keywords associated with the at least one attribute that is generated based at least in part on a word embedding space.

15. The computer program product of claim 14, wherein generating the one or more counterfactual samples comprises using the set of keywords to generate perturbations of the given identified sample.

16. The computer program product of claim 10, wherein the program instructions executable by a computing device further cause the computing device to:
determine an impact of the one or more counterfactual samples relative to the corresponding identified sample at each of a plurality of layers of the machine learning model; and
retrain only a portion of the plurality of the layers of the machine learning model based on the determined impact at each of the layers.

17. A system comprising:
a memory; and
at least one processor operably coupled to the memory and configured for:
identifying one or more samples in a set of data used to train a machine learning model having at least one attribute;
generating one or more counterfactual samples for each of the one or more identified samples;
calculating scores for the one or more identified samples based at least in part on output of the machine learning model with respect to the counterfactual samples, wherein the scores indicate a relative level of bias between the one or more identified samples corresponding to the at least one attribute;
creating an enhanced set of data at least in part by supplementing at least a portion of the identified samples with the corresponding one or more counterfactual samples based on the calculated scores; and
training the machine learning model using the enhanced set of data.

18. The system of claim 17, wherein calculating the score for a given one of the identified samples is based on a comparison of the output of the machine learning model for the given sample with the output of the machine learning model for the corresponding one or more counterfactual samples.

19. The system of claim 17, wherein said creating comprises:
controlling an accuracy of the machine learning model by supplementing only the identified samples having scores above a threshold value with the corresponding one or more counterfactual samples.

20. The system of claim 19, wherein the threshold value comprises a tunable hyperparameter.
